(19) United States
(12) Patent Application Publication
(10) Pub. No.: US 2008/0078716 A1
(43) Pub. Date: Apr. 3, 2008

(54) Bypass oil filter system and method of installing same

(75) Inventor: Thomas A. Farmer, Santa Monica, CA (US)

Correspondence Address: LEWIS, BRISBOIS, BISGAARD & SMITH LLP, 221 NORTH FIGUEROA STREET, SUITE 1200, LOS ANGELES, CA, 90012, US

(73) Assignee: HEPO FILTERS, INC.

(21) Appl. No.: 11/541,063

(22) Filed: Sep. 29, 2006

(51) Int. Cl. B01D 21/24

(52) U.S. Cl. 210/433.1; 210/340; 210/434; 210/455

(57) ABSTRACT

A bypass oil filter system, and a method of installing same, for a vehicle having an engine compartment, an oil lubrication system having a full flow oil filter attached to a free flow oil filter mount and an oil intake line having an oil filler cap comprising, a bypass filter, means to mount the bypass filter in the engine compartment, a sandwich adaptor placed between the full flow oil filter and the full flow oil filter mount, hose means to direct a portion of the oil from the oil lubrication system to the bypass filter and hose means to pass the oil from the bypass filter through the oil filler cap to the oil intake line.

### FIELD OF THE INVENTION

This invention relates to a bypass oil filter system and a method of installing the bypass oil filter system on a vehicle.

### BACKGROUND OF THE INVENTION

Commonly, vehicles having internal combustion engines, have lubrication systems which operate using a full flow oil filter. With a full flow oil filter, all of the circulating oil is passed through the oil filter before it returns to the engine. Bypass oil filters are also known, in which a portion of the circulating oil is passed through a bypass oil filter prior to being returned to the engine.

The full flow filter and the bypass filter differ in their effectiveness. The bypass oil filter is usually more efficient at removing small particles and achieves a higher degree of contaminant removal than the full flow filter, but filters the oil less frequently. The full flow filter filters the oil more often, but uses a relatively coarse filter in order to pass the entire volume of circulating oil required to lubricate the engine. A coarse filter does not remove small contaminants, causing deposits and contributing to engine wear. As dirt accumulates in a full flow filter, the flow of oil is restricted and the filter must be changed often.

Most automobile engines are equipped with only a full flow oil filter. Many vehicle owners, however, desire to add a bypass filter to filter out small contaminants. Bypass filters have been connected to full flow oil systems by various methods, including adapters placed between the full flow filter mounting and the full flow filter itself, which cause a pressure differential which is potentially damaging to the engine. Usually the oil is returned to the engine by making a hole in the oil pan. Punching a hole in the oil pan or otherwise tampering with the engine block is difficult and not advised. It would therefore be very beneficial to provide another means for passing oil to the bypass filter and returning the filtered oil to the engine.

### BRIEF DESCRIPTION OF THE INVENTION

The present invention comprises a bypass oil system for a vehicle and an innovative method for installing the bypass oil filler system on vehicles, particularly the Ford Motor Company Crown Victoria and Mercury Marquis automobiles. The installation method comprises a modification to the original configuration of the front end bumper support structure, installation of a special bypass filter system mounting plate secured to the modified structure, installation of an adapter device interposed between the engine oil filter mount and the existing spin-on full flow oil filter.

The adapter device has a fluid port for directing a steam of pressurized engine oil via a hose or tubing to the inlet port of the bypass oil filter system. The return of the filtrate from the bypass filter system to the engine is accomplished by passing the filtrate through a hose or tubing, connecting the outlet port of the bypass filter system to a swivel fitting mounted coaxially to a special replacement engine oil filler cap, thereby directing the filtrate stream directly into the engine oil filler location.

This method for installing a bypass oil filter system assures that the bypass filter is securely mounted to a sturdy vehicle structure, out of harm's way from foreign object damage that may occur during vehicle use, while also providing a means for providing a stream of pressurized engine oil to the bypass filter, which would be extremely difficult to obtain by other means. The return of the filtrate through the oil filler cap obviates the necessity of alterations, such as drilling holes into engine components for the return. A swivel fitting on the filler cap obviates the necessity of removing the hose connection to the filler cap when the cap is rotated to remove it for refilling engine oil.

### OBJECTS OF THE INVENTION

It is an object of the invention to provide a bypass oil filter system for a vehicle that does not require modifications to the engine block.

Another object of the invention is to provide a method of installing a bypass oil filter system on a vehicle in a fast and easy manner.

Yet another object of the invention is to provide a bypass oil filter for a vehicle which will increase the life of the vehicle engine and extend the time between required oil changes.

### BRIEF DESCRIPTION OF THE DRAWINGS

FIG. 1 is a diagrammatic view of the bypass filter system of this invention;

FIG. 2 is an exploded view of the sandwich adaptor;

FIG. 3 is an exploded view of the modified oil filler cap;

FIG. 4 is an assembled view of the modified oil filler cap; and,

FIG. 5 is an exploded view of the engine filter mount, the sandwich adaptor and the full flow filter element.

### DETAILED DESCRIPTION OF THE INVENTION

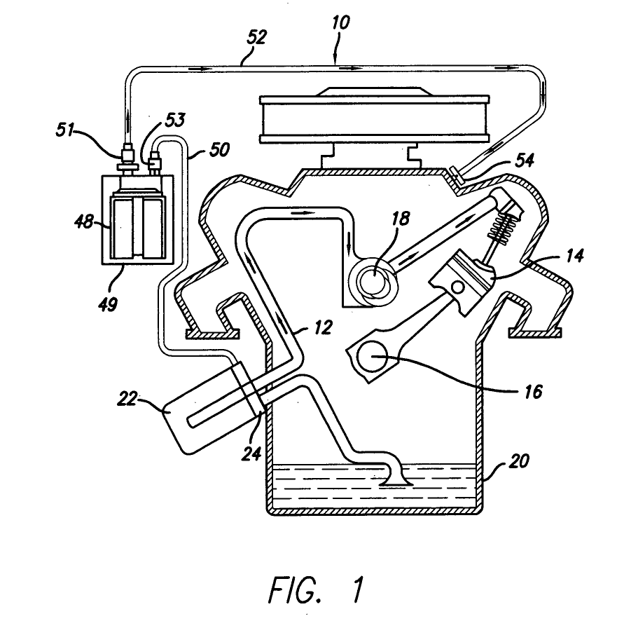

Referring now to FIGS. 1-5 there is shown in FIG. 1, a diagrammatic view of a typical engine compartment 10 of a vehicle, including the oil lubrication system 12. The engine compartment contains pistons 14, bearings 16, camshaft 18 and oil pan 20.

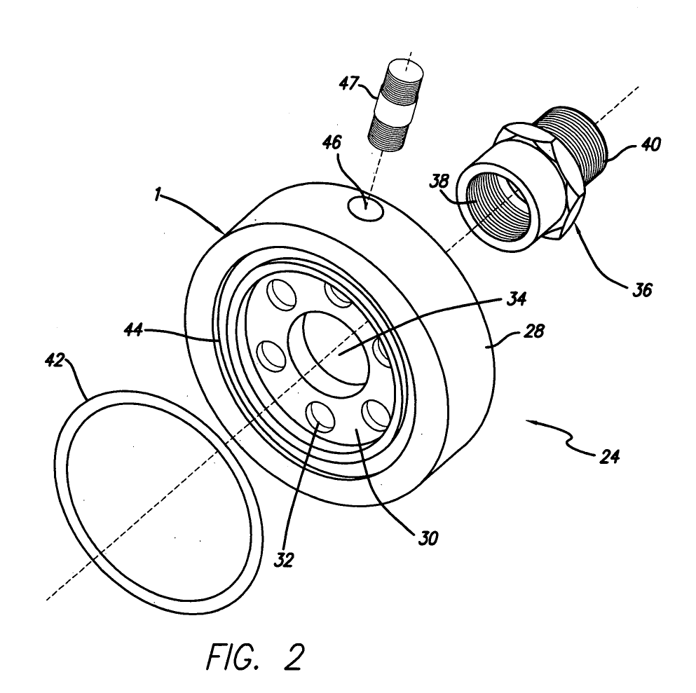

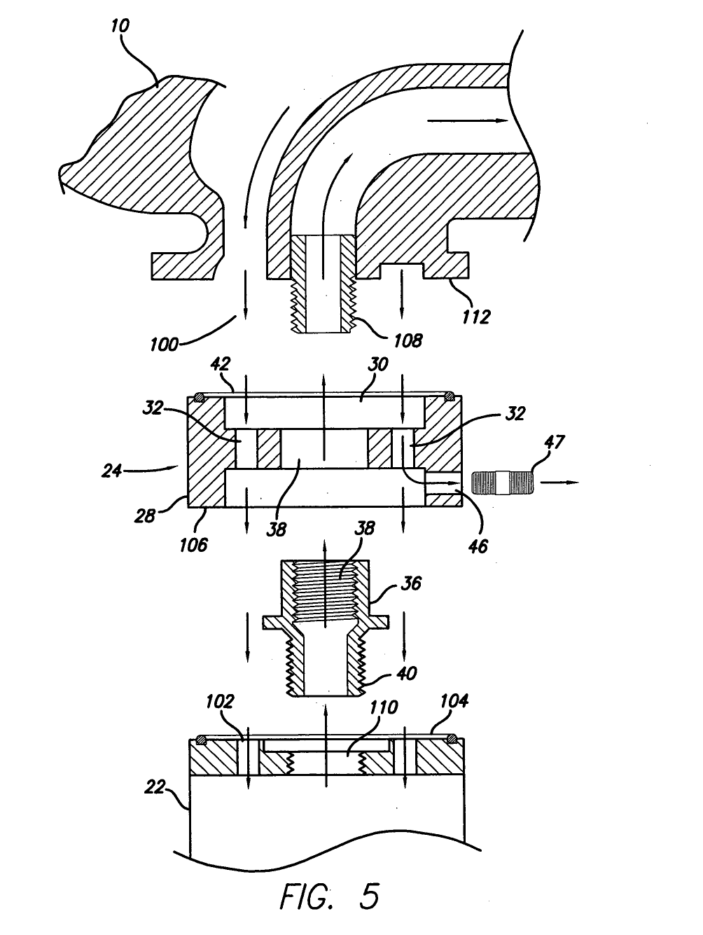

A standard full flow oil filter 22 receives oil from the engine oil pump (not shown) taken from oil pan 20 and, in the usual vehicle, causes the oil that has passed through full flow filter 22, to be forced under pressure to the camshaft 18, the pistons 14 and other lubricated engine components. In the system of this invention, a sandwich adaptor 24, best shown in FIG. 2, is placed between the full flow filter 22 and the full flow filter mount 112, see FIG. 5.

A bypass filter 48 is mounted on a retainer 49 fixed to the modified front bumper structure, described below. Hose 50 carries oil from sandwich adaptor 24 to bypass filter 48 and hose 52 carries oil from the bypass filter to the oil filler cap 54. Fittings 51 and 53 are attached on the head of bypass filter 48 for attachment of hoses 50 and 52.

Referring to FIG. 2, sandwich adaptor 24 comprises a circular body 28 having a circular inset area 30. Inset area 30 has a plurality of outer holes 32 and a central hole 34. Adaptor nut 36 fits into central hole 34 and has internal threads 38 which threadably connect to the external threads of the male fitting 108 centrally located and part of the engine full flow filter mount 112. Adaptor nut 36 has a threaded extension 40 which threadably retains the relocated full flow filter 22. An o-ring 42 fits into groove 44 in body 28 to seal sandwich adaptor 24 to the face of the engine filter mount 112.

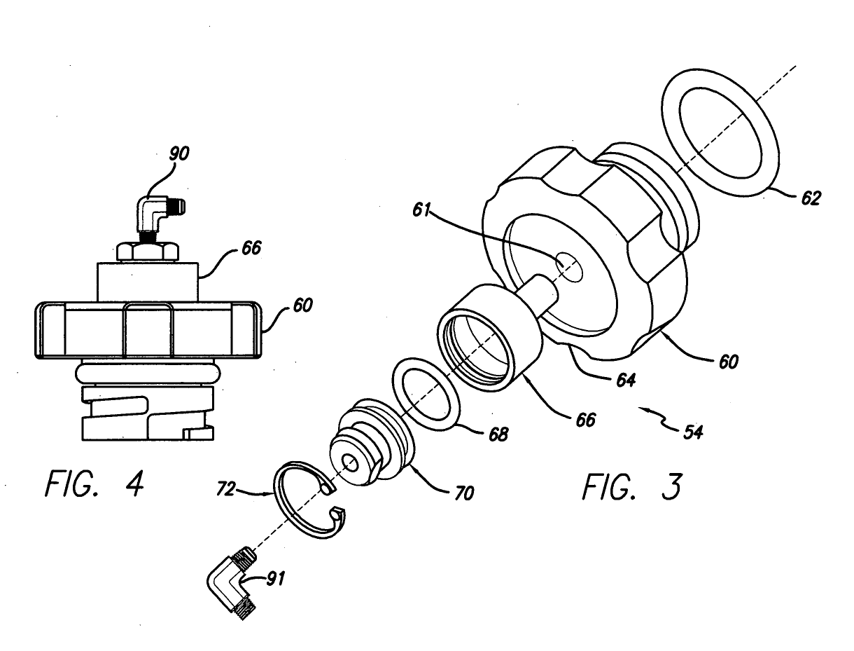

Body 28 has a transverse hole 46 adapted to receive a male hydraulic fitting connector 47 through which a portion of the engine oil passes from sandwich adaptor 24 to bypass filter 48 through hose 50. After passing through bypass filter 48, clean oil is returned via hose 52 to oil filler cap 54, shown in more detail in FIG. 3. Bypass filter 48 is fixedly attached to bypass filter retainer 49 by a bracket affixed to retainer 49, the bracket holding bypass filter 48. By the use of this sandwich adaptor 24, there is no pressure differential created on the oil flow going to the bypass filter and the full flow filter.

Referring now to FIG. 3, there is shown modified oil filler cap 54. Oil filler cap 54 comprises knob 60 having o-ring sealer 62. Knob 60 attaches to the oil filler line which passes oil into the engine block 10. Knob 60 has a central bore 61 for passage of oil received from bypass filter 48 through hose 52. On the top 64 of knob 60 there is attached a swivel mount connector, comprising swivel body 66, which has o-ring sealer 68, and swivel plug 70. Retaining ring 72 holds swivel plug 70 in place.

Male fitting 91 threadably attaches to swivel plug 70. Hose 52 connects to male fitting 91 for delivery of the filtrate from bypass filter 48 through oil filler cap 54 into the oil filler line into engine block 10.

When oil filler cap 54 is removed in order to change oil or add additional oil, hose 52 does not need to be disconnected from male fitting 91, because of swivel body 66, allowing cap 54 to turn without hose 52 turning.

Referring now to FIG. 5, there is shown the engine compartment 10 in which oil flows, under pressure, from the engine oil pump (not shown) through passage 100 into sandwich adaptor 24. As stated above, sandwich adaptor 24 has a circular body 28 and a circular inset area 30. Inset area 30 has a plurality of outer holes 32 and a center hole 34, see FIG. 2. O-ring 42 fits into groove 44 in body 28, better shown in FIG. 2.

Incoming oil then flows through outer holes 32 into full flow filter 22 through full flow filter circular entry passage 102. The oil then passes through the oil filter element inside of full flow filter 22 where it is cleaned. The oil then passes back up the center 110 of full flow filter 22, through the center hole 34 of sandwich adaptor 24 and back into the engine to lubricate the engine components. Full flow filter 22 has an o-ring 104 to seal it against the lower face 106 of sandwich adaptor 24.

Sandwich adaptor 24 and full flow filter 22 are held together in an oil tight manner by adaptor nut 36 having threaded extension 40 which threadably retains full flow filter 22. Adaptor nut 36 has internal threads 38 which threadably attach to full flow filter spud 108 which is connected to engine block 10. O-rings 42 and 104 provide an oil tight seal of the parts described.

As described above, a portion of the incoming oil from the oil pump passes through transverse hole 46 to which is attached connector 47 and hose 50 for passage to bypass filter 48 for more effective cleaning.

This above described bypass oil filter system can be installed in less than 30 minutes. The installation was accomplished on a Ford Crown Victoria as follows:
1. With the vehicle elevated to facilitate access, find and remove the “retainer”, a standard part of the front-end bumper support structure.
2. Remove the “snap clips” normally found on the retainer and reinstall the retainer on the vehicle, reversed in direction.
3. Install a filter mounting plate and bracket onto the retainer.
4. Install two fittings 51 and 53 onto the bypass filter head.
5. Remove the full flow filter 22 from the vehicle.
6. Install male connector 47 on sandwich adaptor transverse hole 46.
7. Install the sandwich adaptor 24 between full flow filter 22 and full flow filter mount 112.
8. Install one male elbow 91 on swivel fitting 70, on new oil filler cap 54.
9. Remove the original oil filler cap and replace with the new oil filler cap 54 which now has swivel fitting 70 and male elbow 91.
10. Route the necessary hoses and cut to length; attach the hose coupling fittings
11. Connect the inlet and outlet hose ends to the new bypass filter 48.
12. Bolt the new bypass filter 48 into place on the modified retainer.
13. Connect the inlet hose end of hose 50 to the male connector 47 on the sandwich adaptor 24.
14. Replace the full flow filter 22 onto the sandwich assembly adaptor nut 36.
15. Connect the oil return hose to the elbow 91 on the swivel fitting 70 on the oil filler cap 54.
16. Secure hoses with cable ties.

The vehicle is now ready to operate in the usual manner and the oil will enter the bypass filter for cleaning as discussed above.

Once installed, the bypass filtration system of this invention filters about 5% of the oil on each pass through. It filters about ½ quart of oil per minute, so that every 12-14 minutes the entire oil content of the vehicle is filtered by the bypass filter.

The average full flow filter of a standard vehicle, such as the Crown Victoria, will filter particle sizes of about 25-35 microns or greater. Particles of about 1 to 20 microns are the most damaging. The bypass filter of this invention will filter particles down to 1 micron, when using filters such as a HEPO filter.

Using the bypass filter of this invention, oil drainage and replacement intervals are extended by 300%, such as every 3 months instead of every month. The vehicle engine will last 600% to 700% longer due to the increased filtration of contaminants, down to 1 micron.

Having thus described the invention, we claim:

1. A bypass oil filter system for a vehicle having an engine compartment, an oil lubrication system having a full flow oil filter attached to a full flow oil filter mount, an oil intake line having an oil filler cap, and a front bumper support structure which has a retainer, comprising, a bypass filter, means to mount the bypass filter on the retainer of the front bumper support structure, non-pressure differential means to direct a portion of the oil from the oil lubrication system to the bypass filter and means to pass the oil from the bypass filter through the oil filler cap to the oil intake line.

2. The bypass oil filter system of claim 1 in which the means to divert a potion of the oil comprises a sandwich adaptor placed between the full flow oil filter and the full flow oil filter mount.

3. The bypass oil filter system of claim 1 in which the means to pass the oil from the bypass filter to the oil intake line comprises an oil filler cap having a central bore and a hose connecting the bypass filter to the oil filler cap.

4. The bypass oil filter system of claim 3 in which the oil filler cap further comprises a swivel mount.

5. The bypass oil filter system of claim 2 in which the sandwich adaptor comprises a circular body having a transverse hole through which a portion of the oil is passed to the bypass filter.

6. A bypass oil filter system for a vehicle having an engine compartment, an oil lubrication system having a full flow oil filter attached to a full flow oil filter mount, an oil intake line having an oil filler cap and a front bumper support structure having a retainer, comprising, a bypass filter, means to mount the bypass filter to the front bumper support structure retainer, a sandwich adaptor between the full flow oil filter and the full flow oil filter mount, a transverse hole in the sandwich adaptor through which a portion of the oil is passed to the bypass filter and means to pass the oil from the bypass filter to the oil intake line.

7. The bypass oil filter system of claim 6 in which the means to pass the oil from the bypass filter to the oil intake line comprises an oil filler cap having a central bore and a hose connecting the bypass filter to the oil filler cap.

8. The bypass oil filter system of claim 6 in which the sandwich adaptor has a plurality of holes adapted to receive oil from the oil lubrication system and a central hole for returning oil to the engine compartment.

9. The bypass oil filter system of claim 6 in which the oil filler cap comprises a swivel mount.

10. The bypass oil filter system of claim 6 in which the oil filler cap comprises an elbow fitting attached to the swivel mount.

11. A method of installing a bypass oil filter in a vehicle comprising an engine compartment, a full flow oil filter and a retainer as part of a front end bumper support structure comprising:
removing the retainer, from the front end bumper support structure;
reinstalling the retainer on the vehicle, reversed in direction;
installing a filter mounting plate and bracket onto the retainer;
installing two fittings onto the bypass filter;
remove the full flow filter from the vehicle;
installing a connector on a transverse hole of a sandwich adaptor;
installing the sandwich adaptor between the full flow filter and the full flow filter mount;
installing one elbow fitting on a swivel on a new oil filler cap;
removing the original oil filler cap and replacing it with the new oil filler cap, which has the swivel with the elbow fitting;
routing and connecting hoses and attaching the hose coupling fittings;
connecting the inlet and outlet hose ends to the bypass filter;
bolting the bypass filter into place;
connecting the inlet hose end to the male connector on the sandwich adaptor;
replacing the full flow filter onto the sandwich assembly adaptor nut; and,
connecting the oil return hose to the elbow on the swivel fitting on the oil filler cap.
